(19) United States
(12) Patent Application Publication
(10) Pub. No.: US 2010/0078952 A1
(43) Pub. Date: Apr. 1, 2010

(54) Self-righting tongs

(76) Inventor: J. Kevin Hurson, Orange Beach, AL (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 12/285,256

(22) Filed: Oct. 1, 2008

(51) Int. Cl. A47J 43/28

(52) U.S. Cl. 294/99.2; 294/118

(57) ABSTRACT

Self-righting tongs including a pair of handles that are connected together. A pair of jaws is affixed to the handles. At least one of the jaws is provided with a mass that is greater than the combined mass of both of the handles.

### FIELD OF THE INVENTION

The present invention relates generally to handling, hand and hoist-line implements and, more particularly, to tong-type implements.

### BACKGROUND OF THE INVENTION

It is well known that the consumption of food contaminated by microscopic organisms or germs can cause disease. Sufficiently pathogenic germs can kill. For these reasons, food must be handled with meticulous care, especially in commercial kitchens where food for large numbers of people is prepared.

Cleanliness reduces the likelihood that germs will be spread in a kitchen. People preparing food for human consumption must wash their hands. Countertops and work surfaces must be washed regularly. And, all implements for making and serving food must be sanitized.

Tongs are one implement widely found in sanitary kitchens. Tongs have dozens of uses, but most frequently are employed to lift, carry, turn, and serve food. Unfortunately, germs spread from dirty hands and work surfaces can sometimes foul the handles of tongs.

The handles of conventional tongs lay flat on work surfaces when set down and are easily contaminated by germs on the work surfaces. These handles can contact food and spread disease-causing germs. A need, therefore, exists for tongs that can sustain themselves in an upright position when released from a hand of a user to minimize the spread of germs.

### SUMMARY OF THE INVENTION

In light of the problems associated with conventional tongs for preparing and serving food, it is a principal object of the invention to provide self-righting tongs with handles that automatically assume an elevated position when set upon a work surface so as to minimize the likelihood of contamination of the handles by germs. The elevated handles are especially convenient to locate and grasp when preparing and serving food. Furthermore, the handles of my self-righting tongs are unlikely to become fully submerged in liquid-filled pots or bowls.

It is another object of the invention to provide self-righting tongs of the type described that promote hygienic food handling practices. In restaurants, my tongs can be employed at buffets and salad bars to limit the spread of germs.

Another object of the invention is to provide tongs of the type described that are maintained in an elevated position without external supports.

It is another object of the invention to provide self-righting tongs that are intuitive to use, requiring little if any instruction do receive their benefits.

It is an object of the invention to provide improved features and arrangements thereof in tongs for the purposes described which are lightweight in construction, inexpensive to manufacture, and fully dependable in use.

Briefly, the self-righting tongs in accordance with this invention achieves the intended objects by featuring a pair of handles that are connected together. A pair of jaws is affixed to the handles. At least one of the jaws is provided with a mass that is greater than the combined mass of both of the handles. In one embodiment, the handles are connected together at one of their ends and, in another embodiment, the handles are connected between their ends.

The foregoing and other objects, features, and advantages of the present invention will become readily apparent upon further review of the following detailed description of the tongs illustrated in the accompanying drawings.

### BRIEF DESCRIPTION OF THE DRAWINGS

The present invention may be more readily described with reference to the accompanying drawings, in which:

FIG. 1 is a top view of self-righting tongs in accordance with the present invention.

FIG. 2 is a perspective view of the self-righting tongs of FIG. 1.

FIG. 3 is a side view of the self-righting tongs of FIG. 1 with a different, unbalanced positioning thereof being shown in broken lines.

FIG. 4 is a perspective view of an alternative embodiment of my self-righting tongs.

FIG. 5 is a side view of the self-righting tongs of FIG. 4 with a different, unbalanced positioning thereof being shown in broken lines.

Similar reference characters denote corresponding features consistently throughout the accompanying drawings.

### DETAILED DESCRIPTION OF THE PREFERRED EMBODIMENTS

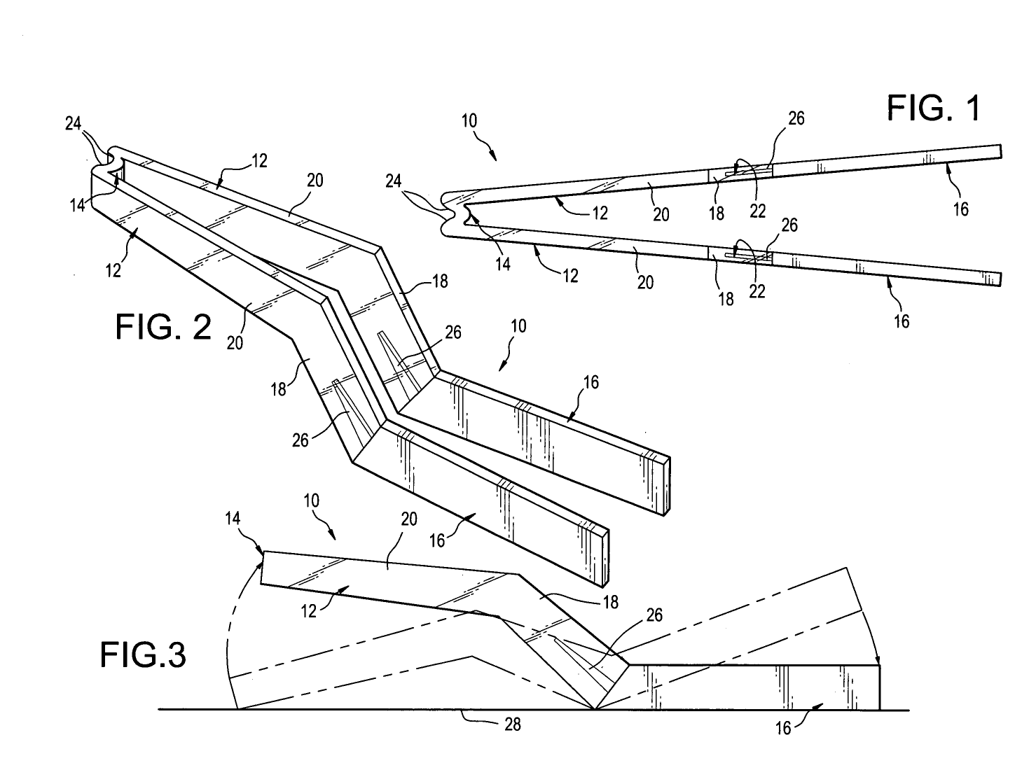

Referring now to FIGS. 1-3, self-righting tongs in accordance with the present invention are shown at 10. Tongs 10 include a pair of elongated handles 12 connected together by a spring hinge 14 in a tweezers-like manner. One of a pair of weighted jaws 16 is respectively affixed to the free end of each of handles 12.

Handles 12 are formed from a resilient plastic material. Each of handles 12 has a shape resembling that of an inverted “V” when viewed from the side with a lower handle member 18 being connected to an upper handle member 20 at an obtuse angle. Each of lower handle members 18 is provided with a tapered socket 22 at its free end. Each of the upper handle members 20 is sized to fit into the hand of a user for a comfortable grip.

Spring hinge 14 is made from a resilient plastic material and is integrally formed with handles 12. Spring hinge 14 has a pair of hinge members 24 that are connected together at an acute angle. The free ends of hinge members 24 are connected to the free ends of upper handle members 20 such that handles 12 become farther apart moving away from spring hinge 14 for easily grasping food between handles 12. The connection of hinge members 24 is placed between upper handle members 20 so as to provide tongs 10 with a shape like that of an “M” when viewed from above.

Jaws 16 are formed from metal or other suitably dense material. Jaws 16 are long and narrow bars having dimensions that are approximately the same as those of upper handle members 20. Jaws 16 are connected to lower handle members 18 at an obtuse angle that places upper handle members 20 and jaws 16 in substantially parallel planes with lower handle members 18 sloping between the parallel planes.

The connection of jaws 16 to handles 12 is facilitated by pins 26. As shown, a pin 26 is integrally formed with, and projects upwardly and rearwardly from, each of jaws 16. Pins 26 have a tapered, pyramidal form that resists turning when snugly inserted into correspondingly shaped sockets 22 in lower handle members 18. A layer of adhesive cement (not shown) on pins 26 retains them permanently in place within sockets 22.

The configuration of jaws 16 can be varied in accordance with their intended purpose and is a matter of design choice. For example, jaws 16 can be provided with tines for serving spaghetti or can be provided with slots for draining lettuce. Paddle-like jaws are excellent for grasping loose materials and stirring foods. Unadorned bars, like those serving as jaws 16 in FIGS. 1-3, provide excellent, all-around, gripping surfaces.

The weight of jaws 16 is set so as to maintain jaws 16 flush with supporting surface 28 while handles 12 and spring hinge 14 are cantilevered from jaws 16 above surface 28. It is expected, therefore, that jaws 16 will weigh slightly more than handles 12 and spring hinge 14 together. Jaws 16 can, of course, weigh more than this, but extra weight can add to the cost of tongs 10 and make them somewhat more tiring to use for extended periods.

Jaws 16 can be weighted in a variety of ways. The preferred way of weighting jaws 16 is, as indicated above, by forming them wholly from a dense material. Alternatively, separate weights can be attached to the exterior of jaws 16 or can be embedded within jaws 16. Such weighting arrangements are deemed equivalent if handles 12 are elevated or tipped upright solely by gravity acting upon jaws 16.

The use of tongs 10 is straightforward. First, handles 12 are grasped lightly between the thumb and remaining fingers of a user's hand and tongs 10 are elevated above supporting surface 28. Next, handles 12 are moved to a place where jaws 16 are positioned on opposite sides of an item to be lifted, say, a meatball. Now, handles 12 are slowly squeezed together against the resistive force of spring hinge 14 so that the meatball is gently grasped by jaws 16. After transporting the meatball to the desired location, it can be released from jaws 16 simply by releasing the squeeze upon handles 12. Then, tongs 10 can be set back down upon surface with the weight of jaws 16 retaining handles 12 above surface. Any germs or dirt that may have passed from the user's hands to handles 12 cannot contaminate surface 28 or pass to food on surface 12. After use of tongs 10 is completed, tongs 10 can be washed with soap and water and, then, stored in a convenient location for immediate reuse.

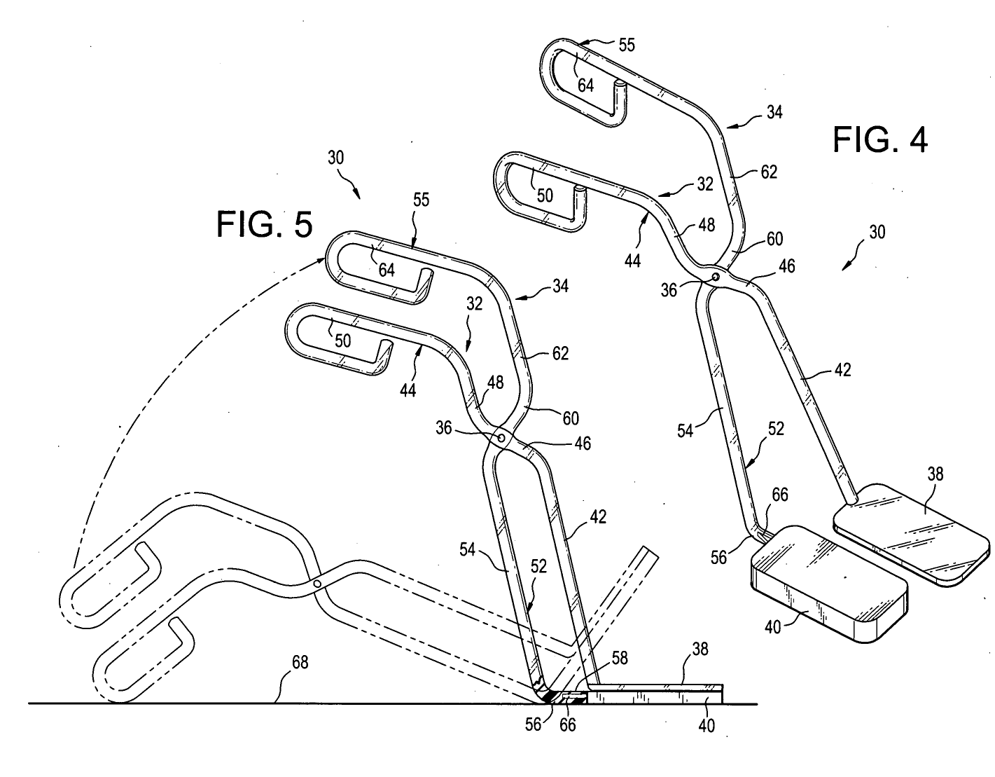

With reference to FIGS. 4 and 5, alternative tongs 30 can be seen. Tongs 30 include a pair of elongated handles 32 and 34 connected together by a pivot pin 36 in a scissors-like manner. A lightweight jaw 38 is affixed to the lower, free end of handle 32. A heavily weighted jaw 40 is affixed to the lower, free end of handle 34.

Handle 32 is formed from a resilient plastic material and has a serpentine shape when viewed from the side. Handle 32 includes a lower handle member 42 that is connected to an upper handle member 44 at an obtuse angle. Lower handle member 42 is connected to, and extends upwardly and rearwardly from, paddle-like jaw 38 that is integrally formed therewith. Upper handle member 44 has a bottom segment 46, through which pivot pin 36 passes, which is connected to, and extends upwardly and rearwardly from, lower handle member 42. Upper handle member 44 also has a medial segment 48 that is connected to, and extends upwardly and rearwardly from, bottom segment 46 so as to be parallel with lower handle member 42. Upper handle member 44 also has a top segment 50 that is connected to, and extends upwardly and rearwardly from, medial segment 48 and is formed into a loop that is normally positioned below top segment 50 and is sized to receive fingers from a hand of a user.

Handle 34 is formed from a resilient plastic material and has a serpentine shape when viewed from the side. As shown, handle 34 includes a lower handle member 52 that is connected to an upper handle member 55 at an obtuse angle. Lower handle member 52 has an upper segment 54 that is connected to, and extends upwardly and rearwardly from, a lower segment 56. Lower segment 56 is provided with a socket 58 at its free end. Upper handle member 55 has a bottom segment 60, through which pivot pin 36 passes, which is connected to, and extends upwardly and forwardly from, upper segment 54. Additionally, upper handle member 55 has a medial segment 62 that is connected to, and extends upwardly and rearwardly from, bottom segment 60 so as to be parallel with upper segment 54. Upper handle member 55 also has a top segment 64 that is connected to, and extends upwardly and rearwardly from, medial segment 62 and is formed into a loop that is sized to receive fingers from a hand of a user.

Pivot pin 36 connects handles 32 and 34 together. Pivot pin 36 passes through the centers of segments 46 and 60 that are flattened somewhat for reinforcement purposes. Pivot pin 36 is shown to be a rivet with enlarged heads on its opposite ends but can be a screw which permits tongs 30 to be disassembled for easy cleaning, reconditioning and repair.

Jaw 40 is formed from metal or other dense material. Jaw 40 is a flat, long and narrow bar that is held horizontally. Jaw 40 is connected to handle 34 at an obtuse angle relative to segments 52 and 55. Jaw 40 has an outline that is substantially the same as that of jaw 38 and will snugly engage jaw 38 from below when top segments 50 and 64 are squeezed together. The configuration of jaws 38 and 40 can be varied in accordance with their intended purpose and is a matter of design choice.

The connection of jaw 40 to handle 34 is facilitated by a pin 66. Pin 66 is integrally formed with, and projects rearwardly from, jaw 40. Pin 66 has a tapered, pyramidal form that resists turning when snugly inserted into the correspondingly shaped socket 58 in lower handle member 52. A layer of adhesive cement placed on pin 66 retains it permanently in place within socket 58.

The weight of jaw 40 is set so as to maintain jaw 40 flush with a supporting surface 68 while handles 32 and 34 are cantilevered from jaws 38 and 40 above surface 68. Jaw 40 will weigh slightly more than the combined weight of handles 32 and 34. Jaw 40 can be provided with additional weight if desired.

Jaw 40 can be weighted in many ways. One manner of weighting jaw 40 is by forming them wholly from a dense metal. Also, one or more weights (not shown) can be attached to the exterior of jaw 40 or can be embedded within jaw 40.

As with tongs 10, the use of tongs 30 is straightforward. First, the top segments 50, 64 of handles 32, 34 are grasped lightly with the thumb and remaining fingers of a user's hand and tongs 30 are elevated above supporting surface 68. Next, handles 32, 34 are moved to a place where jaws 38, 40 are positioned on opposite sides of an item to be lifted. Now, handles 32, 34 are squeezed together so that the item is grasped by jaws 38, 40. After transporting the item to the desired location, the item can be released from jaws 38, 40 and set down by moving the thumb and fingers of the user's hand away from one another. Then, tongs 30 can be placed upon surface with the weight of jaw 40 retaining handles 32, 34 above surface. Any germs or dirt that may have passed from the user's hands to handles 32, 34 cannot contaminate surface 68 or pass to food on surface 68. After use of tongs 30 is completed, tongs 30 can be washed with soap and water and, then, stored in a convenient location for reuse.

While tongs 10 and 30 have been described with a high degree of particularity, it will be appreciated by those skilled in the art that modifications can be made to them. Therefore, it is to be understood that the present invention is not limited to tongs 10 and 30, but encompasses any and all tongs within the scope of the following claims.

I claim:

1. Self-righting tongs, comprising:
a pair of handles being connected together;
a pair of jaws, each of said jaws being affixed to one of said handles; and,
at least one of said jaws being provided with a mass that is greater than the combined mass of both of said handles.

2. Self-righting tongs, comprising:
a pair of handles having opposed ends and being connected together at one of said opposed ends;
a pair of jaws, each of said jaws being affixed to a respective one of said handles; and,
said jaws being provided with a total mass that is greater than the total mass of both of said handles.

3. Self-righting tongs, comprising:
a pair of handles having opposed ends and being pivotally connected together at a location positioned between said opposed ends;
a pair of jaws, each of said jaws being affixed to one of said opposed ends of a respective one of said handles; and,
one of said jaws being provided with a total mass that is greater than the total mass of both of said handles.
